(19) United States
(12) Patent Application Publication
(10) Pub. No.: US 2013/0039638 A1
(43) Pub. Date: Feb. 14, 2013

(54) METHOD FOR PLAYING BACK THREE DIMENSIONAL IMAGES

(71) Applicants: Chih-Yin Chiang, Nantou County (TW); Hsiu-Hung Lin, New Taipei City (TW)

(72) Inventors: Chih-Yin Chiang, Nantou County (TW); Hsiu-Hung Lin, New Taipei City (TW)

(21) Appl. No.: 13/555,189

(22) Filed: Jul. 22, 2012

(30) Foreign Application Priority Data
Aug. 10, 2011 (TW) 100128588

(51) Int. Cl. H04N 5/93; H04N 5/917

(52) U.S. Cl. 386/355; 386/353; 386/E05.028; 386/E05.007

(57) ABSTRACT

Method for playing back three-dimensional (3D) images includes inputting an original video file; decoding the original video file for obtaining a plurality of images corresponding to a plurality of frames; dividing each of the plurality of images into a plurality of dissected images according to an input format of the original video file; and merging the dissected images into a playback file. When the original video file is played, the dissected images of the playback file are read and rendered for playing back a corresponding 3D image. When playing back the original video file, the hardware system only performs simple tasks such as reading and rendering the dissected images, and does not require performing complicated tasks such as decoding and dividing images, consequently reducing system resources consumed and increasing playback efficiency.

### BACKGROUND OF THE INVENTION

1. Field of the Invention

The present invention is related to a method for playing back three-dimensional images, and more particularly, to a method which consumes less system resources, for playing back three-dimensional images.

2. Description of the Prior Art

Three-dimensional (3D) display technology is gaining popularity in recent years, especially in the entertainment industry. Playing back three-dimensional videos however, requires significant system resources.

Since related 3D industrial standards have not been clearly established, utilizing software to playback 3D videos provides more compatibility than utilizing hardware for playback. Since the hardware and/or configuration of each computer may not be exactly the same, system resources consumed to playback 3D videos are different for different computers. One conventional approach to improving system resource consumption is to increase a number of cores of the central processing unit (CPU), or utilizing a graphic processing unit (GPU) to take charge of the operation.

However, the central processing unit of the computer, such as CPU of a notebook, owned by a user may not include multiple cores, or may not possess a high clock rate. Moreover, the computer of a user may not include an independent graphics card, or may not include a video chipset with hardware acceleration ability. Consequently, problems such as frame drop and video/audio being out of sync may occur. Such problems may become even more severe when resolution or coding complexity of the 3D video increases, causing inconvenience during viewing of the 3D video.

### SUMMARY OF THE INVENTION

An embodiment of the present invention discloses a method for playing back three-dimensional images. The method comprises inputting an original video file; decoding the original video file, for obtaining a plurality of images corresponding to a plurality of frames; dividing each of the plurality of images into a plurality of dissected images according to an input format of the original video file; merging the plurality of dissected images into a playback file; reading the plurality of dissected images of the playback file when playing back the original video file; and rendering the plurality of dissected images, for playing back a corresponding three-dimensional image.

Another embodiment of the present invention discloses a method for playing back three-dimensional images. The method comprises inputting an original video file; decoding the original video file, for obtaining a plurality of images corresponding to a plurality of frames; dividing each of the plurality of images into a plurality of first dissected images of a first file format according to an input format of the original video file; converting the plurality of first dissected images into a plurality of second dissected images of a second file format; merging the plurality of second dissected images into a playback file; reading the plurality of second dissected images of the playback file when playing back the original video file; and rendering the plurality of second dissected images, for playing back a corresponding three-dimensional image.

Therefore, when the original video file is being played back, the system is not required to perform complicated tasks such as decoding or image dividing, so less system resources are consumed and the playback efficiency can be increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a hardware system.

FIG. 2 is a flowchart illustrating a method for playing back three-dimensional images according to an embodiment of the present invention.

FIG. 3 is a diagram illustrating when the input format of the original video file comprises two views, each image obtained from decoding is divided into two dissected images according to an embodiment of the present invention.

FIG. 4 is a diagram illustrating when the input format of the original video file comprises four views, each image obtained from decoding is divided into four dissected images according to another embodiment of the present invention.

FIG. 5 is a diagram illustrating when the input format of the original video file comprises eight views, each image obtained from decoding is divided into eight dissected images according to another embodiment of the present invention.

FIG. 6 is a flowchart illustrating a method for playing back three-dimensional images according to another embodiment of the present invention.

FIG. 7 is a diagram illustrating playback efficiency improvement after being processed by the method for playing back three-dimensional images of the present invention.

### DETAILED DESCRIPTION

The purpose of the present invention is to process in advance steps (e.g. decoding or file conversion, etc.) that demand the most system resources in playing back a 3D video file, before the 3D video file is played. This way the system does not require processing such steps that heavily demand system resources in real time when a user plays back the 3D video file.

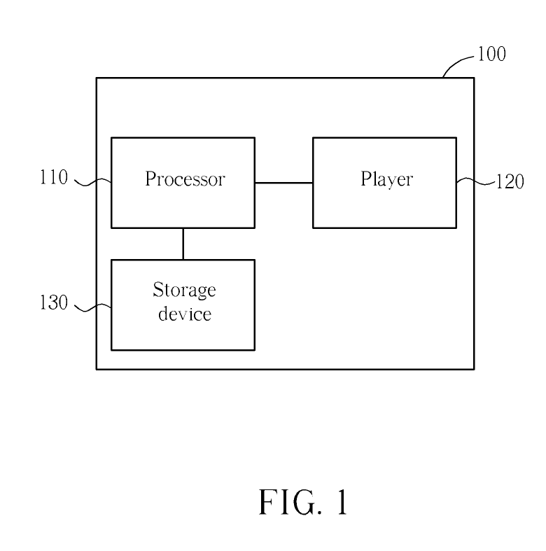

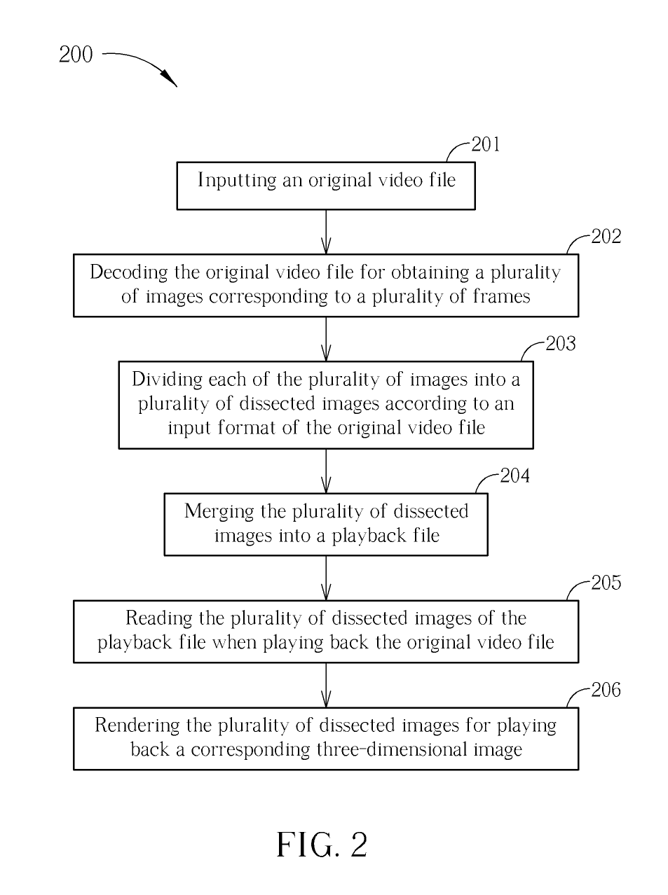

Please refer to FIG. 1 and FIG. 2. FIG. 1 is a diagram illustrating a hardware system 100. The hardware system 100 comprises a processor 110, a player 120 and a storage device 130. The hardware system 100 can be, for instance, a desktop computer, a laptop computer, a tablet, a smart phone or a home multimedia theater system, etc. The processor 110 is coupled to the player 120 and the storage device 130. FIG. 2 is a flowchart illustrating a method 200 for playing back three-dimensional images according to an embodiment of the present invention. Steps of the method 200 include:

Step 201: inputting an original video file;

Step 202: decoding the original video file, for obtaining a plurality of images corresponding to a plurality of frames;

Step 203: dividing each of the plurality of images into a plurality of dissected images according to an input format of the original video file;

Step 204: merging the plurality of dissected images into a playback file;

Step 205: reading the plurality of dissected images of the playback file when playing back the original video file; and

Step 206: rendering the plurality of dissected images, for playing back a corresponding three-dimensional image.

The original video file can be a three-dimensional video file stored in the storage device 130 of the hardware system 100. In step 202, a number of the plurality of images obtained from decoding the original video file corresponds to a number of frames comprised in the original video file. Since the three-dimensional video file can have different input formats, content of the plurality of images obtained from decoding the original video file in the step 202 may differ according to the input format of the original video file.

In step 203, dividing each of the plurality of images into the plurality of dissected images according to the input format of the original video file is dividing each of the plurality of images into a number of dissected images according to a corresponding number of views corresponding to the original video file. For instance, if the input format of the original video file comprises two views (left and right), each image obtained from decoding in step 202 is then divided into two dissected images in step 203. Generally, the number of views of the input format of the original video file can be 2, 4, 8 . . . etc.

In step 204, all of the dissected images obtained from step 203 are merged into one playback file. This way, the user still sees one single file, and the user does not need to choose which video of the left view or the right view (or other views) is played.

Prior to playing back the original video file, the processor 110 performs steps 201-204. For instance, when the original video file is stored in the storage device 130 of the hardware system 100, the processor 110 of the hardware system 100 performs steps 201-204 on the original video file. In another embodiment, the processor 110 may perform steps 201-204 after the user has opened the original video file, but before playing back the original video file (e.g. before the user has clicked the “play” function button).

When the user starts playing the original video file, the player 120 of the hardware system 100 only needs to read the plurality of dissected images from the playback file (step 205), and render the plurality of dissected images for playing back a corresponding three-dimensional image (step 206). Since steps 201-204 were already completed prior to the original video file being played, video coding required to be processed in steps 205-206 is relatively simple. Therefore, when playing the original video file, the hardware system 100 or the player 120 does not need to perform complicated tasks such as decoding of step 202 and image dividing of step 203, so system resources consumed can be reduced and playback efficiency can be increased.

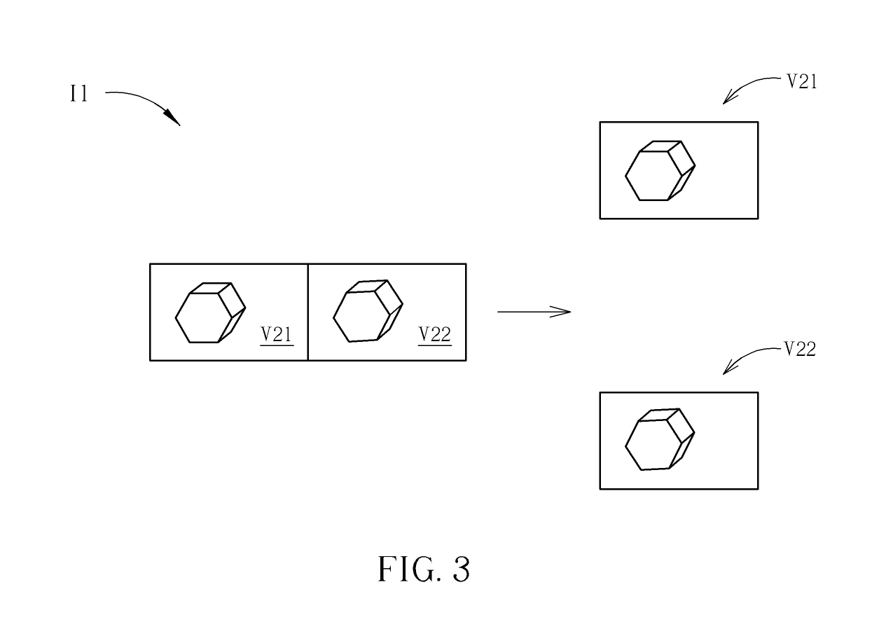

Please refer to FIG. 2 and FIG. 3. FIG. 3 is a diagram illustrating the input format of the original video file comprising two views, so that each image obtained from decoding in step 202 is divided into two dissected images in step 203 according to an embodiment of the present invention. In FIG. 3, an image I1 is one of images obtained from decoding in step 202. As shown in FIG. 3, since the input format of the original video file comprises two views, the image I1 is divided into two dissected images V21 and V22 corresponding to the views of the left eye and the right eye respectively in step 203.

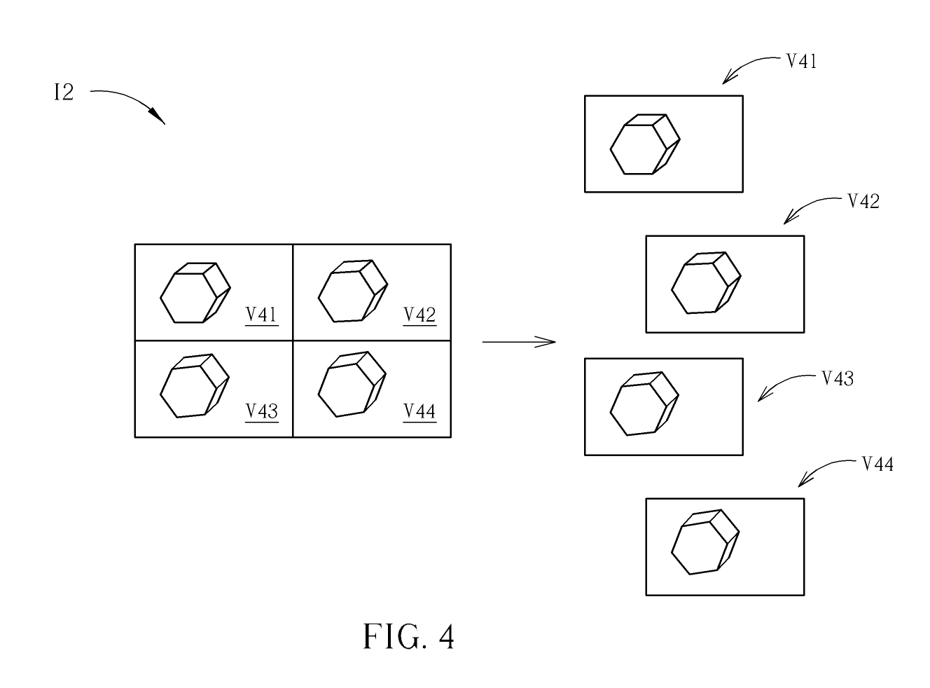

Please refer to FIG. 2 and FIG. 4. FIG. 4 is a diagram illustrating the input format of the original video file comprising four views, so that each image obtained from decoding in step 202 is divided into four dissected images in step 203 according to another embodiment of the present invention. In FIG. 4, an image I2 is one of images obtained from decoding in step 202. As shown in FIG. 4, since the input format of the original video file comprises four views, the image I2 is divided into four dissected images V41, V42, V43 and V44, in an order of upper left, upper right, lower left and lower right respectively.

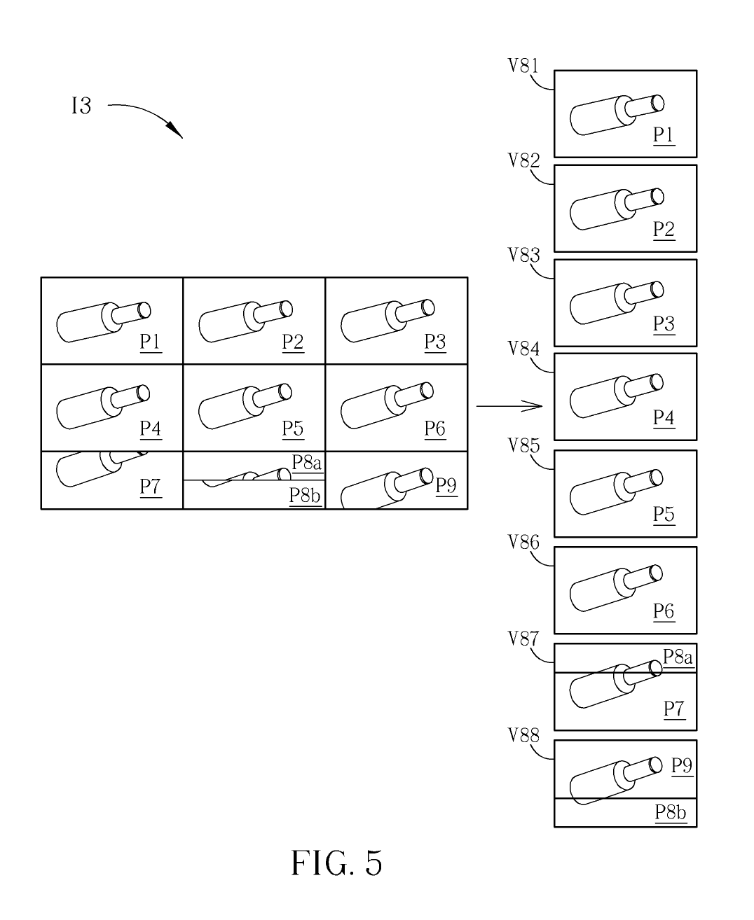

Please refer to FIG. 2 and FIG. 5. FIG. 5 is a diagram illustrating the input format of the original video file comprising eight views, so that each image obtained from decoding in step 202 is divided into eight dissected images in step 203 according to another embodiment of the present invention. In FIG. 5, an image I3 is one of images obtained from decoding in step 202. As shown in FIG. 5, since the input format of the original video file comprises eight views, the image I3 is firstly divided into nine parts P1, P2, P3 . . . and P9, where six parts P1, P2, P3 . . . and P6 correspond to dissected images V81, V82, V83, V84, V85 and V86 respectively. Dissected images V87 and V88 are then obtained according to the remaining three parts P7, P8 and P9. For instance, an upper part P8a of the part P8 is integrated with the part P7 to form the dissected image V87, and a lower part P8b of the part P8 is integrated with the part P9 to form the dissected image V88. This way, the image I3 can be divided into 8 dissected images V81, V82, V83 . . . and V88, which correspond to the eight views comprised by the input format of the original video file.

The order of dividing images obtained from decoding in step 202 into dissected images is not limited to the embodiments shown in FIG. 3, FIG. 4 and FIG. 5. Images obtained from decoding in step 202 can be divided into dissected images in other orders or arrangements according to practical demands. For instance, in FIG. 4, the image 12 can be divided into four dissected images V41, V42, V43 and V44, in an order of upper right, upper left, lower left and lower right respectively.

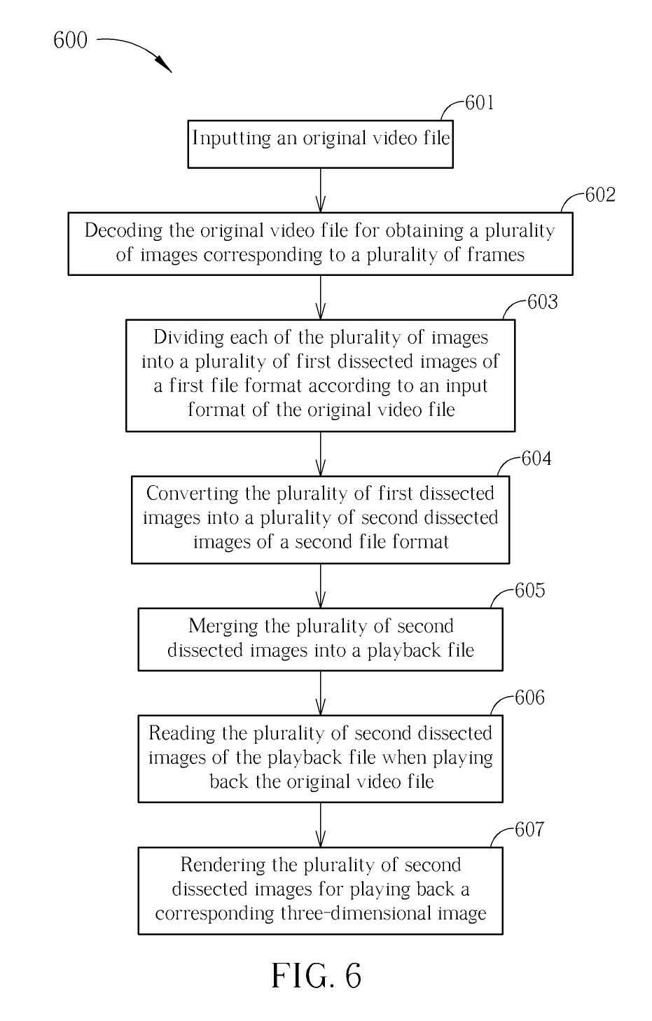

Please refer to FIG. 6. FIG. 6 is a flowchart illustrating a method 600 for playing back three-dimensional images according to another embodiment of the present invention. Steps of the method 600 include:

Step 601: inputting an original video file;

Step 602: decoding the original video file for obtaining a plurality of images corresponding to a plurality of frames;

Step 603: dividing each of the plurality of images into a plurality of first dissected images of a first file format according to an input format of the original video file;

Step 604: converting the plurality of first dissected images into a plurality of second dissected images of a second file format;

Step 605: merging the plurality of second dissected images into a playback file;

Step 606: reading the plurality of second dissected images of the playback file when playing back the original video file; and

Step 607: rendering the plurality of second dissected images for playing back a corresponding three-dimensional image.

The method 600 of FIG. 6 is similar to the method 200 of FIG. 2, and a difference is that the method 600 further converts the first dissected images of the first file format to the plurality of second dissected images of the second file format. For instance, the plurality of images obtained from decoding the original video file in step 602 can be RAW format, so the first file format of the plurality of first dissected images in step 603 is also RAW. In the present embodiment, the second file format can be a compressed image format, such as JPEG or PNG, etc., but is not limited to these. In other words, the file size of the second dissected image of the second file format is smaller than the corresponding first dissected image of the first file format. In step 603, approaches of dividing each of the plurality of images into the plurality of first dissected images according to the input format of the original video file can be similar to FIG. 3, FIG. 4 and FIG. 5.

When the original video file is not played, the processor 110 performs steps 601-605. When the original video file is played, the player 120 of the hardware system 100 only needs to read the plurality of second dissected images from the playback file (step 606), and renders the plurality of second dissected images for playing back the corresponding three-dimensional image (step 607). Since steps 601-605 were already completed prior to the original video file being played, video coding required to be processed in steps 606-607 is relatively simple. Therefore, when the original video file is played, the hardware system 100 or the player 120 does not need to perform complicated tasks, such as decoding of step 602, image dividing of step 203 and file format conversion of step 604, etc. This way, system resources consumed can be reduced and playback efficiency can be increased. Furthermore, since the file size of the plurality of second dissected images is significantly smaller after the file format is converted, the method 600 can also save storage space, in addition to increasing playback efficiency similar to method 200.

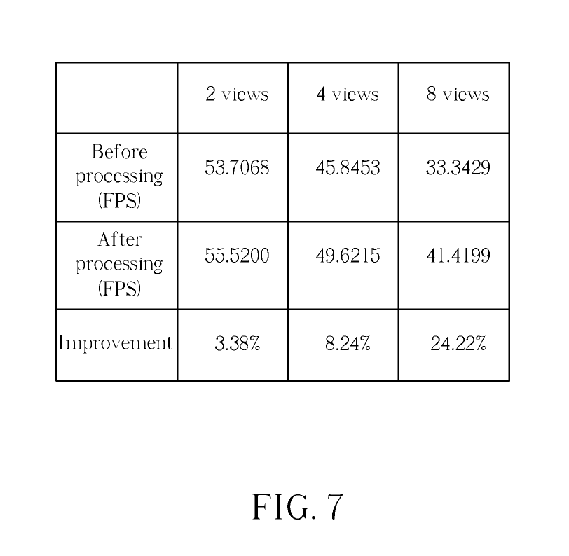

Please refer to FIG. 7. FIG. 7 is a diagram illustrating playback efficiency improvement after being processed by the method for playing back three-dimensional images of the present invention. Through experimentation, it is observed that the playback efficiency (i.e. the playback efficiency can correspond to frame rate, or frames per second, etc.) of utilizing the method for playing back three-dimensional images of the present invention is higher than playback efficiency without utilizing the method for playing back three-dimensional images of the present invention. As shown in FIG. 7, the method for playing back three-dimensional images of the present invention is especially effective for videos with a higher number of views, meaning the more views comprised by the original video file, the greater the improvement in playback efficiency is obtained by utilizing the method for playing back three-dimensional images of the present invention.

In conclusion, the method for playing back three-dimensional images of the present invention performs steps (e.g. decoding, image dividing and file format conversion, etc.) with complicated coding, and consumes most system resources prior to the original video file being played. When the original video file is played, the player or the hardware system only needs to run simple tasks, such as reading and rendering, etc., for playing back the corresponding three-dimensional video. During the original video file being played back, the system is not required to perform complicated tasks such as decoding or image dividing, so less system resources are consumed and the playback efficiency can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for playing back three-dimensional images, comprising:
inputting an original video file;
decoding the original video file, for obtaining a plurality of images corresponding to a plurality of frames;
dividing each of the plurality of images into a plurality of dissected images according to an input format of the original video file;
merging the plurality of dissected images into a playback file;
reading the plurality of dissected images of the playback file when playing back the original video file; and
rendering the plurality of dissected images, for playing back a corresponding three-dimensional image.

2. The method of claim 1, wherein dividing each of the plurality of images into the plurality of dissected images according to the input format of the original video file, is dividing each of the plurality of images into a number of dissected images according to the number of views corresponding to the original video file.

3. The method of claim 1, wherein steps of reading the plurality of dissected images of the playback file when playing back the original video file, and rendering the plurality of dissected images for playing back the corresponding three-dimensional image are performed by a player.

4. The method of claim 1, wherein steps of reading the original video file, decoding the original video file for obtaining the plurality of images corresponding to the plurality of frames, dividing each of the plurality of images into the plurality of dissected images according to the input format of the original video file, and merging the plurality of dissected images into the playback file are performed by a processor before the original video file is played back.

5. The method of claim 4, wherein steps of reading the plurality of dissected images of the playback file when playing back the original video file, and rendering the plurality of dissected images for playing back the corresponding three-dimensional image are performed by a player.

6. A method for playing back three-dimensional images, comprising:
inputting an original video file;
decoding the original video file, for obtaining a plurality of images corresponding to a plurality of frames;
dividing each of the plurality of images into a plurality of first dissected images of a first file format according to an input format of the original video file;
converting the plurality of first dissected images into a plurality of second dissected images of a second file format;
merging the plurality of second dissected images into a playback file;
reading the plurality of second dissected images of the playback file when playing back the original video file; and
rendering the plurality of second dissected images, for playing back a corresponding three-dimensional image.

7. The method of claim 6, wherein steps of reading the plurality of second dissected images of the playback file when playing back the original video file, and rendering the plurality of second dissected images, for playing back the corresponding three-dimensional image are performed by a player.

8. The method of claim 6, wherein file size of each image of the plurality of second dissected images is smaller than file size of a corresponding first dissected image.

9. The method of claim 8, wherein the first file format is RAW format.

10. The method of claim 8, wherein the second file format is JPEG format.

11. The method of claim 6, wherein steps of decoding the original video file for obtaining the plurality of images corresponding to the plurality of frames, dividing each of the plurality of images into the plurality of first dissected images of the first file format according to the input format of the original video file, converting the plurality of first dissected images into the plurality of second dissected images of the second file format and merging the plurality of second dissected images into the playback file are performed by a processor before the original video file is played back.

12. The method of claim 11, wherein steps of reading the plurality of second dissected images of the playback file when playing back the original video file, and rendering the plurality of second dissected images, for playing back the corresponding three-dimensional image are performed by a player.
